(19) United States
(12) Patent Application Publication
(10) Pub. No.: US 2001/0024285 A1
(43) Pub. Date: Sep. 27, 2001

(54) Image processing apparatus

(76) Inventor: Tsuyoshi Kondo, Fukuoka-shi (JP)

Correspondence Address: STEVENS, DAVIS, MILLER & MOSHER, L.L.P., 1615 L Street, N.W., Suite 850, Washington, DC, 20036, US

(21) Appl. No.: 09/810,471

(22) Filed: Mar. 19, 2001

(30) Foreign Application Priority Data
Mar. 24, 2000 (JP) 2000-084320

(51) Int. Cl. G06K 1/00; B41J 1/00; B41B 1/00; G06F 15/00

(52) U.S. Cl. 358/1.1

(57) ABSTRACT

An image processing apparatus which converts received drawing commands into intermediate lists expressed by simple commands, and stores the lists, and which creates a page image from the intermediate lists, includes a polygon dividing means and a trapezoid dividing means so as to holds intermediate lists for shapes of the polygon and the trapezoids, thereby it is possible to reduce the volume of the intermediate lists.

### BACKGROUND OF THE INVENTION

The present invention relates to an image processing apparatus which carries out formation of an image from drawing commands, and which stores data once in an intermediate list, and thereafter forms an image from the intermediate list.

### RELATED ART

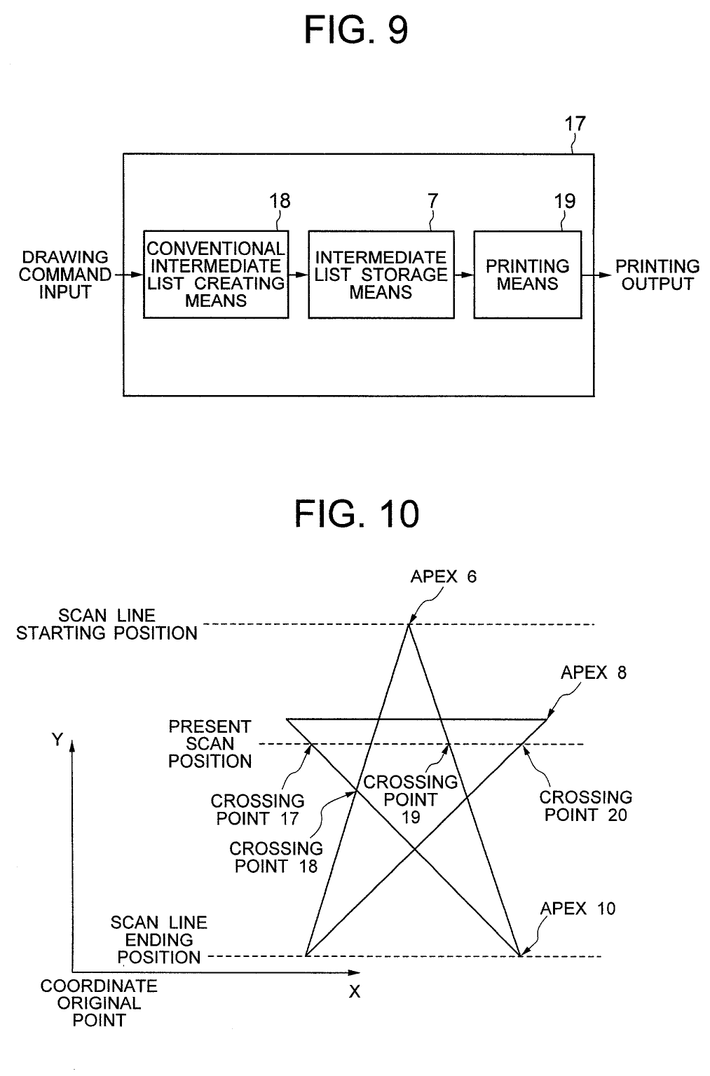

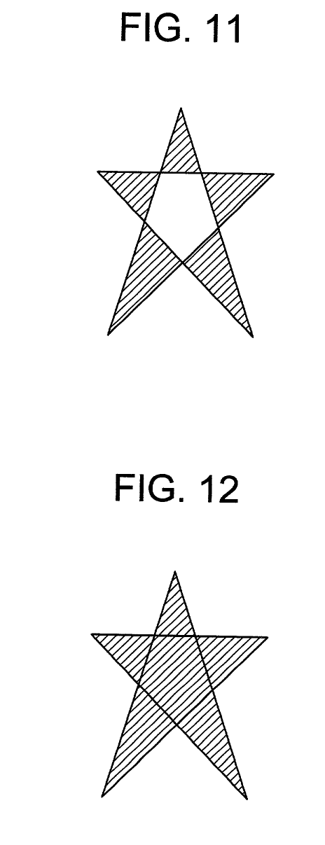

Explanation will be made of a conventional image processing apparatus with reference to FIGS. 9 to 12. FIG. 9 is a block diagram which shows a conventional image processing apparatus, FIG. 10 is a view which shows a scan created image in the conventional image processing apparatus, FIG. 11 is view which shows an example of alternate paint-over in the conventional image processing apparatus, and FIG. 12 is a view which shows an example of winding paint-over.

Referring to FIG. 9 which shows a conventional image processing apparatus 17 in which drawing commands transmitted from a host computer create an intermediate list including line data having a width l and bit map data, by means of a conventional intermediate list creating means 18, in the conventional intermediate list creating means 18, if the inputted drawing commands are for bit-map drawing, bit map data is subjected to CMYK color spatial conversion and dithering into binary data, but if the inputted drawing commands are for vector (including characters) drawing such as polyline drawing, polygon drawing or Bezier drawing, data concerning a paint-over part is converted into a group of line data (which will be hereinbelow denoted as “scan lines”) for the width l.

Explanation will be made of the manner of creation of scan lines with reference to FIG. 10 which shows a system of X-Y coordinates having an origin of coordinates in the lower left part, as shown in the figure, and which also shows a polygon, as an example, having apices 6, 7, 8, 9 and 10 which are connected by sides in the mentioned order, the final apex 10 being connected to the apex 6 from which the connection is initiated, by a side.

At first, as to the Y-coordinate, a maximum value and a minimum value are obtained, and are then used as a position of initiation of scan lines, and a position of end of scan lines, respectively. The creation of the scan lines is carried out by using information of sides and crossing points as to the Y-coordinate, from the position of initiation of scan lines to the position of end of scan lines.

Referring to FIG. 10, there are presented four crossing points 17, 18, 19, 20 at which a dotted line shown at the present scanning position crosses sides of a pattern. In this case, ascending numbers are attached to the cross points in the order according to X-coordinate value for the sake of convenience in explanation. However, since the crossing points are actually extracted from apex data, if the apex date s are stored in the order of the ascending numbers, the crossing points are detected in the order of the points 18, 20, 17, 19 which are then sorted in the ascending order of X-ordinate values. There are two paint-over mode as to command data for paint-over, one of which is an alternate mode for alternately painting between the sorted crossing points, and the other one of which is a winding mode for painting between the first one and the final one of the sorted crossing points. In the case of alternately pointing between the crossing points, a pattern shown in FIG. 11 is obtained while in the case of painting between the first one and the final one of the crossing points, an image shown in FIG. 12 is finally obtained. The shaded parts in the figures are those which have been painted over.

Next, explanation will be hereinbelow made of the creation of the intermediate list in the case of alternately painting between apices. The scan line data at the present position is created so that a scan line formed between the crossing points 17, 18 and a scan line formed between the crossing points 19, 20 are set to data for a paint-over part in the intermediate list. It is noted here that (A, B) indicates the connection between two points one of which has coordinate data A and the other one of which has coordinate data B.

The intermediate list is created so that the scan line data and color data of paint-over which are obtained from the position of initiation of a scan line to a position of end of the scan line are used for data of paint-over. The thus created intermediate list is once stored in an intermediate list storage means 7. After drawing data for a single page is stored in the intermediate list storage means 7, tone modulation is carried out for the intermediate list of the scan lines by a printing means 19, and drawing is made on a page image with the use of superposition data, and drawing is made on the page image for the intermediate list of a bit map with the use of superposition data. Then, the page image is formed from the intermediate lists for a single page data, and, printing is made.

However, in the above-mentioned conventional image apparatus, since the paint-over of vector drawing is developed into scan line data, the size of the intermediate lists becomes larger in the intermediate storage means 7 while if the storage configuration of the intermediate list is set for apex data of the original drawing commands, there has been raised a time consuming problem during creation of an image by the printing means.

### BRIEF SUMMARY OF THE INVENTION

In order to solve the above-mentioned problems, according to the present invention, an intermediate list is created so that a part to be painted over in the intermediate list of vector drawing are in the form of polygon data or trapezoidal data, and accordingly, the storage size for the intermediate list is reduced in comparison with such a case that the intermediate list of scan lines is stored. Thus, the time taken for the creation of an image by the printing means is reduced in comparison with such a case that the intermediate list of apex data of drawing commands is stored, thereby it is possible to aim at distributing loads between the creation part and the printing part of the intermediate list.

According to the first aspect of the present invention, there is provided an image processing apparatus for converting received drawing commands into an intermediate list which is exhibited by simple commands, which is then stored, and from which a page image is formed, comprising an intermediate list format selecting means for selecting a format of an intermediate list in accordance with the drawing commands, a polygon dividing means for dividing a pattern into polygons, a paint-over determining means for determining whether the interior of a polygon is a part to be painted-over or not, a first intermediate list creating means for creating an intermediate list containing polygon data, a second intermediate list creating means for creating an intermediate list containing line data as to a width l or bit map data, an intermediate list storing means for storing the intermediate lists, and a printing means for creating a raster image from the intermediate lists stored in the intermediate storing means in response to printing instructions, and printing the image. With this arrangement, the storage size of the intermediate lists can be decreased.

According to a second aspect of the present invention, there is provided an image processing apparatus for converting received drawing commands into an intermediate list which is exhibited by simple commands, which is then stored, and from which a page image is formed, comprising an intermediate list format selecting means for selecting a format of an intermediate list in accordance with the drawing commands, a polygon dividing means for dividing a pattern into polygons, a paint-over determining means for determining whether the interior of a polygon is a part to be painted-over or not, a trapezoid dividing means for dividing a polygon into a group of trapezoids, a first intermediate list creating means for creating an intermediate list containing trapezoid data, a second intermediate list creating means for creating an intermediate list containing a width l or bit map data, an intermediate list storing means for storing the intermediate lists, and a printing means for creating an raster image from the intermediate lists stored in the intermediate list storing means in accordance with printing instructions and the printing image. With this arrangement, the size of the intermediate lists can be decreased, and the speed of forming an image by the printing means can be increased.

According to a third aspect of the present invention, there is provided an image processing apparatus for converting received drawing commands into an intermediate list which is exhibited by simple commands, which is then stored, and from which a page image is formed, comprising an intermediate list format selecting means for selecting a format of an intermediate list in accordance with the drawing commands, a trapezoid dividing means for dividing a polygon into a group of trapezoids, a first intermediate list creating means for creating an intermediate list containing trapezoid data, a second intermediate list creating means for creating an intermediate list containing line data as to a width l or bit map data, an intermediate list storing means for storing the intermediate lists, and a printing means for creating an raster image from the intermediate lists stored in the intermediate storing means in accordance with printing instructions and printing the image. With this arrangement, the size of the intermediate lists can be decreased, and the speed of forming an image by the printing means can be increased.

### BRIEF DESCRIPTION OF THE INVENTION

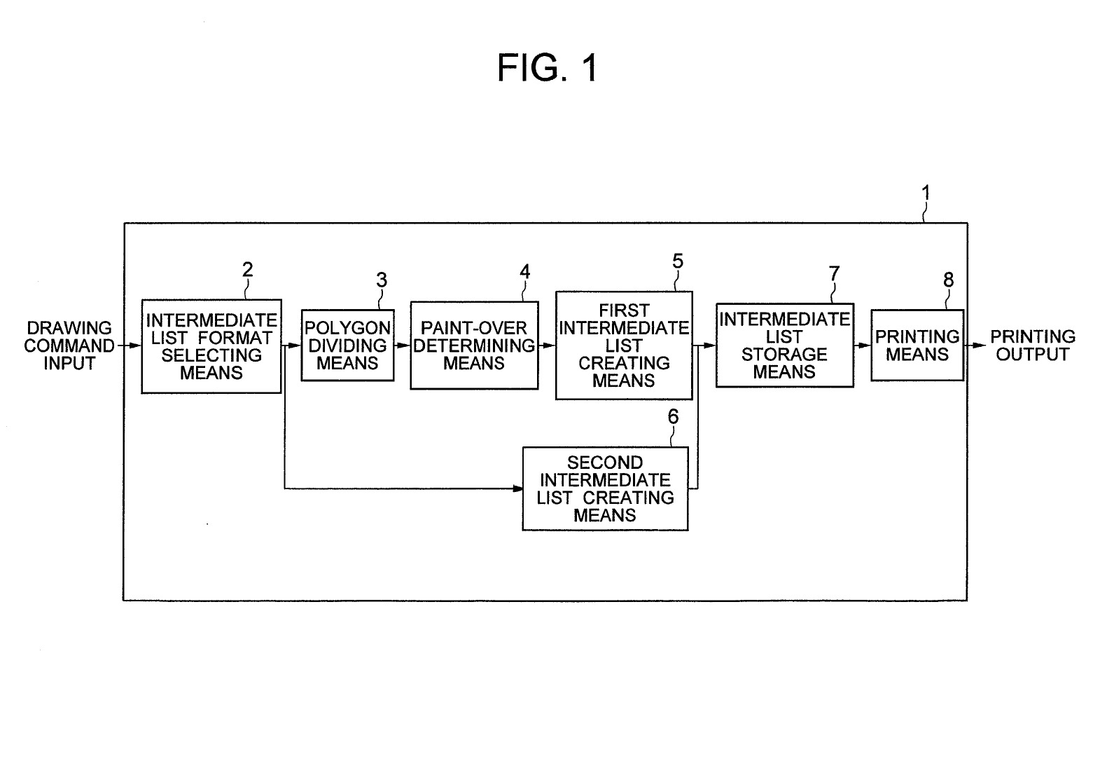

FIG. 1 is a block diagram illustrating an image processing apparatus in a first embodiment of the present invention;

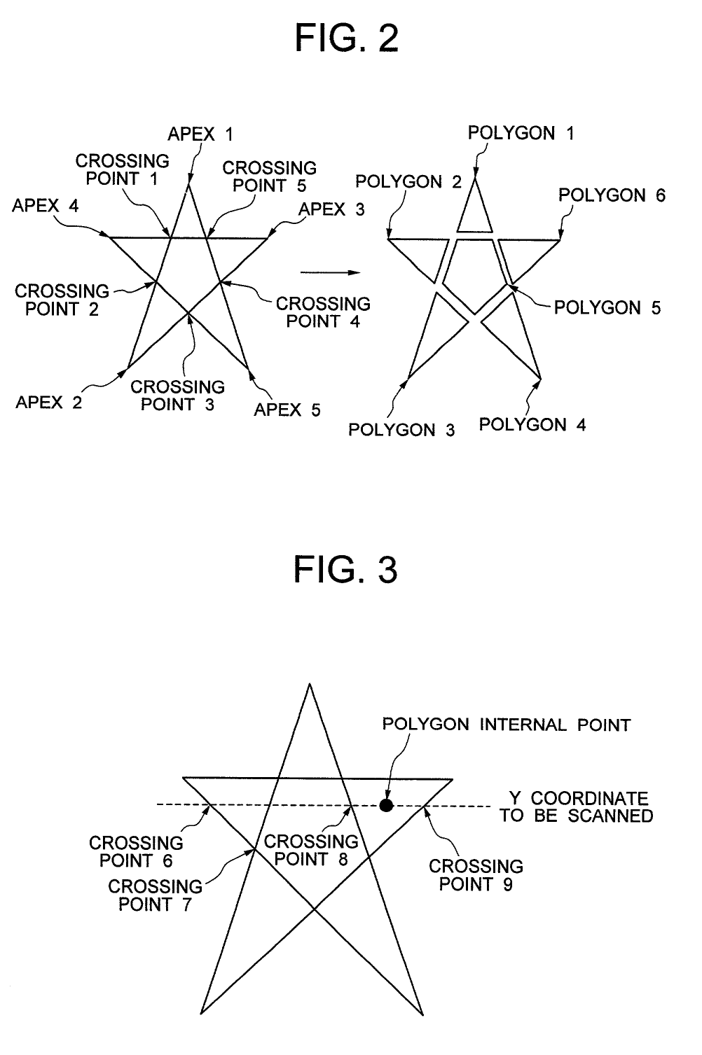

FIG. 2 is a view illustrating an example of division into polygons by the image processing apparatus in the first embodiment;

FIG. 3 is a view illustrating an example of determination of paint-over in the image processing apparatus in the first embodiment;

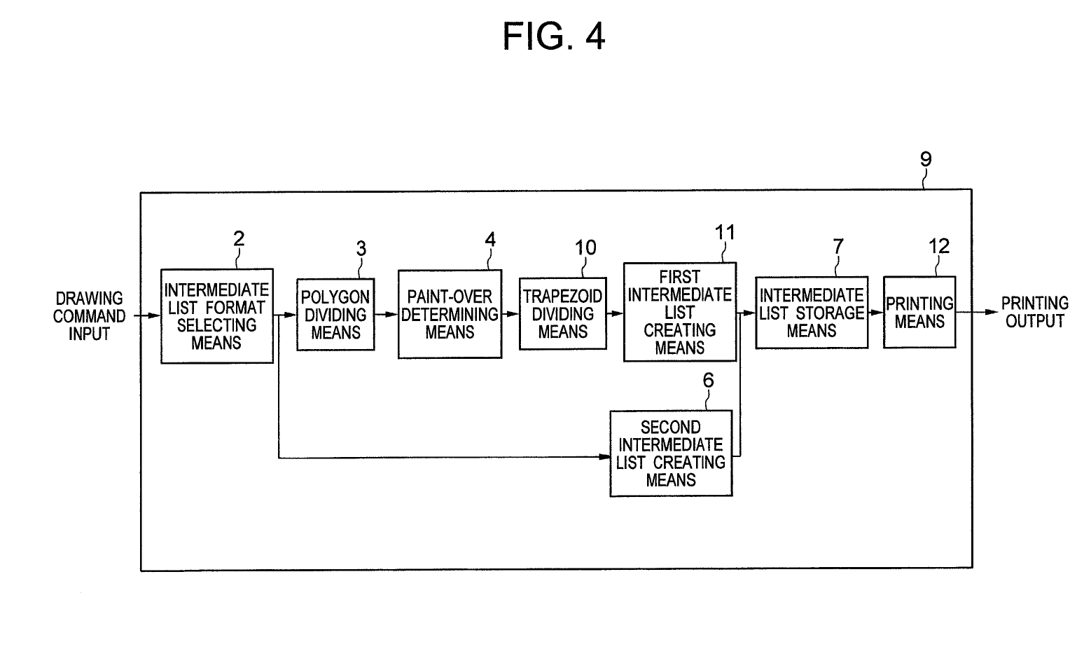

FIG. 4 is a block diagram illustrating an image processing apparatus in a second embodiment of the present invention;

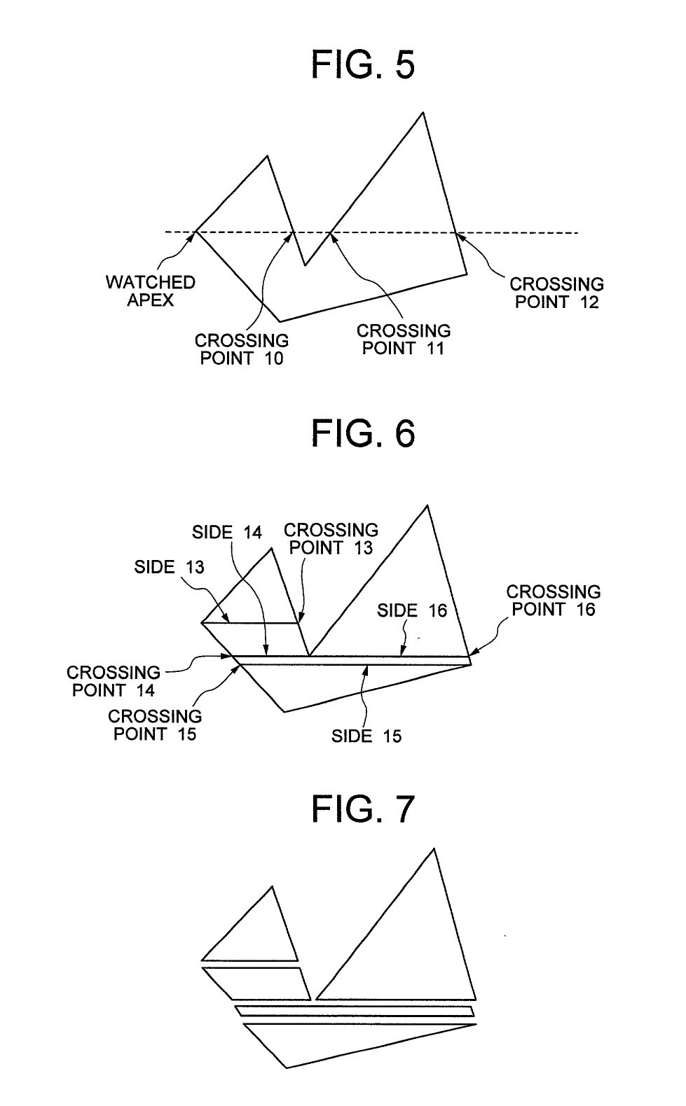

FIG. 5 is a view illustrating creation of crossing points for division into trapezoids in the image processing apparatus in the second embodiment of the present invention;

FIG. 6 is a view illustrating creation of sides of division into the trapezoids in the image processing apparatus in the second embodiment of the present invention;

FIG. 7 is a view illustrating an example of division into trapezoids in the image processing apparatus in the second embodiment of the present invention;

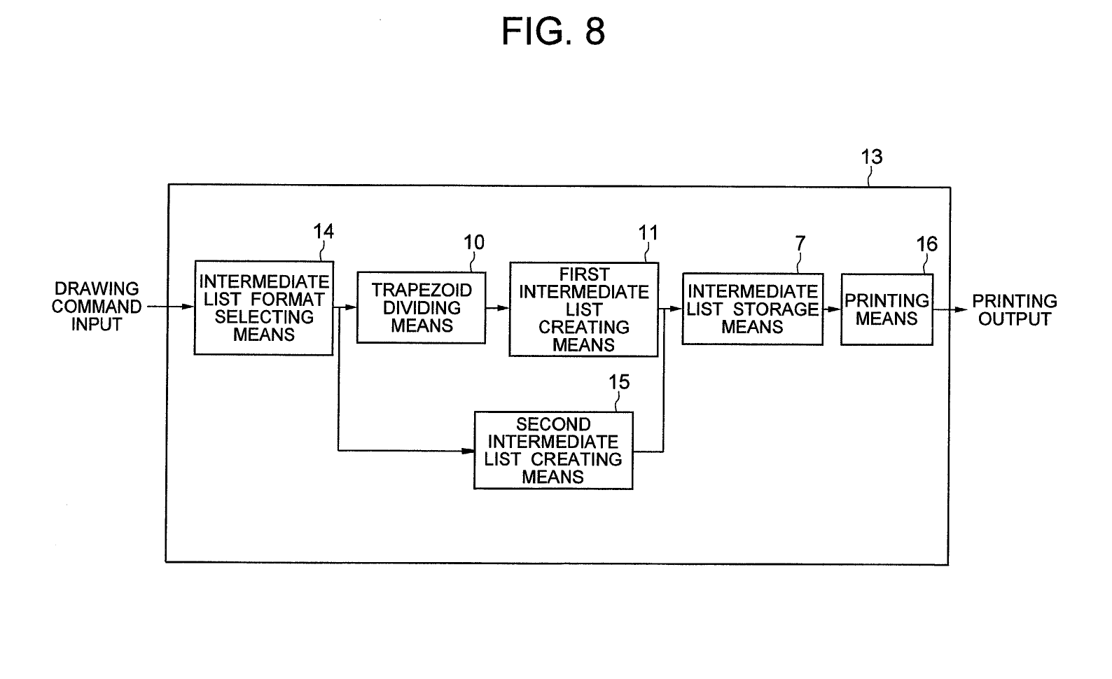

FIG. 8 is a block diagram illustrating an image processing apparatus in a third embodiment of the present invention;

FIG. 9 is a block diagram illustrating a conventional image processing apparatus;

FIG. 10 is a view illustrating scan creation in the conventional image processing apparatus;

FIG. 11 is a view illustrating an example of alternate paint-over in the conventional image processing apparatus; and

FIG. 12 is a view illustrating an example of winding paint-over in the conventional image processing apparatus.

### DESCRIPTION OF PREFERRED EMBODIMENTS

### First Embodiment

Explanation will be hereinbelow made of a first embodiment of the present invention with reference to FIGS. 1 to 3. FIG. 1 is a block diagram which shows an image processing apparatus in the first embodiment of the present invention, FIG. 2 is a view which shows division into polygons in the image processing apparatus in the first embodiment of the present invention, and FIG. 3 is a view which shows an example of paint-over in the image processing apparatus in the first embodiment of the present invention. Referring to FIG. 1, there is shown the image processing apparatus 1 in the first embodiment of the present invention, in its entirety.

Drawing commands fed from a host computer and the like, are delivered at first to an intermediate list format selecting means 2 which selects an intermediate list creating means 6 for creating an intermediate list if the drawing commands relate to bit map drawing (also including character drawing in a bit map expression), but if the drawing commands are vector commands such as character drawing commands in an outline expression, polyline drawing commands, polygon drawing commands or Bazier commands, adds data obtained by converting a part which subjected to outline drawing into polygons, and thereafter, selects a polygon dividing means 3.

The intermediate list creating means 6 carries out color spatial conversion of color data in the bit map drawing commands into a CMYK color space, and then carries out tone modulation so as to create binary CMYK data. The binary CMYK data, drawing position data and superposition data in the bit map drawing commands are combined into an intermediate list which is then stored in an intermediate list storing means 7.

The polygon dividing means 2 divides the vector data into polygons if the vector drawing commands including paint-over data.

The example shown in FIG. 1 is a polygon having 5 apices 1, 2, 3, 4, 5 which are connected through the intermediary of sides in the ascending order of the apex numbers, and then, carries out connection to the first apex 1 through the intermediary of a side from the final apex 5. At first, side data indicating connection among the apices are created. Next, crossing points between the sides are detected from the apex data so that coordinate data for apices of crossing points 1, 2, 3, 4, 5 are added to the above-mentioned side data.

The side data creates line segment data in combination with the apex data and the crossing point data. For example, side data created from the apices 1, 2 is added thereto with data of the crossing points 1, 2 so as to obtain side data having three line data (the apex 1, the crossing point 1), (the crossing point 1, the crossing point 2) and (the crossing point 2, the apex 2). Thus, polygons having therein no line segment for the line segments are extracted from side data containing the thus created line segment data. Thus, a polygon 1, a polygon 2, a polygon 3, a polygon 4, a polygon 5 and a polygon 6 are extracted as shown in FIG. 2.

Next, as shown in FIG. 3, the paint-over determining means 4 determines whether each of the polygons is to be painted over or not. Specifically, the determination is made for the polygon 6 shown in FIG. 2. A point in the polygon 6 is set as a polygon internal point, and crossing points between the Y-axis passing through the internal point and sides are extracted. Then, which space between crossing points the polygon internal point is present is determined when the crossing points are rearranged in the ascending order as to their X-axis values in order to determine whether it is to be painted over or not. If the drawing commands is alternate, it is determined that all polygons other than the polygon 5 shown in FIG. 2 are to be painted over, but if it is winding, it is determined that all polygons are to be painted over.

The intermediate list creating means 5 creates and outputs intermediate list data containing polygons which have been determined to be painted over by the paint-over determining means 4.

The intermediate list storage means 7 stores therein intermediate lists created by the intermediate list creating means 5 and the intermediate list creating means 6, and after it stores intermediate lists for a single page, it delivers them to a printing means 8.

The printing means 8 carries out the creation of scan lines, color conversion and tone modulation, and then, conducts drawing on a page image in accordance with a superposition attribute if the intermediate list concerns a polygon, and also conducts drawing on the page image for intermediate lists for which the tone modulation has been carried out, in accordance with a superposition attribute. The printing is made after the intermediate list for a single page is drawn on the page image, and the printing output is made.

### Second Embodiment

Explanation will be hereinbelow made of a second embodiment of the present invention with reference to FIGS. 2 to 7. FIG. 4 is a block diagram which shows an image processing apparatus in the second embodiment of the present invention, FIG. 5 is a view which shows creation of crossing points through the division into trapezoids in the image processing apparatus in the second embodiment, FIG. 6 is a view which shows creation of sides through the division into trapezoids in the image processing apparatus in the second embodiment, and FIG. 7 is a view which shows an example of the division into trapezoids in the image processing apparatus. Referring to FIG. 4, there is shown the image processing apparatus 9 in the second embodiment of the present invention.

Drawing commands delivered from a host computer and the like are at first inputted into an intermediate list format selecting means 2 which therefore selects an intermediate list creating means 6 if the drawing commands are bit map drawing commands (containing characters expressed by bit maps), but it adds data obtained by converting an outline drawing part into polygons and thereafter selects a polygon dividing means 3 if the drawing commands are vector drawing commands such as character drawing commands in an outline expression, polyline drawing commands, polygon drawing commands or Bezier drawing commands.

The intermediate list creating means 6 carries out color space conversion of color data in the bit map drawing commands, into a CMYK color space, then carries out tone modulation so as to create binary CMYK data. This binary CMYK data, drawing position data in the bit map drawing commands, and superposition data are combined so as to obtain an intermediate list which is then stored in an intermediate list storing means 7.

The polygon dividing means 2 carries out the division into polygons if the vector drawing commands contain paint-over data. An example shown in FIG. 2 is a polygon having five apices 1, 2, 3, 4, 5, which are connected with each other by sides in the order of ascending apex numbers, and carries out connection to the first apex 1 by a side, from the final apex 5. At first, side data indicating connection among apices are created. Next, crossing points between sides are detected in view of apex data, and coordinate data of crossing points 1, 2, 3, 4, 5 are added to the above-mentioned side data, respectively. Polygons having no line segment therein, for each line segments are extracted from the side data containing the thus created line segment data. Thus, a polygon 1, a polygon 2, a polygon 3, a polygon 4, a polygon 5 and a polygon 6 are extracted, as shown in FIG. 2.

As shown in FIG. 3, the paint-over determining means 4 determines whether the respective polygons are to be painted over or not. Crossing points between the Y-coordinate and sides are extracted by using a point in the polygon 6 as an internal point, and by determining which space between crossing points the polygon internal point is located when the crossing points are rearranged in the order of ascending X-ordinate values, whether it is to be painted over or not is determined. If the drawing commands are alternate, it is determined that all polygons other than the polygon 5 are to be painted. However if it is winding, it is determined that all polygons are to be painted over.

The trapezoid dividing means 10 carries out pattern division of each of the polygons which is determined to be painted over by the paint-over determining means 4, into trapezoids. An example of the division into trapezoids is shown in FIG. 5 to 7. The trapezoid dividing means 10 creates at first side data connecting between the apices. Thus, with the use of Y-coordinate values of the apices, crossing points between a line parallel to the X-axis, and the sides are obtained. Crossing points 10, 11, 12 are created for watched apices in the polygon shown in FIG. 5. Then, the watched apices and the crossing points are rearranged in the order of ascending X coordinate values, and whether a line segment connecting crossing points before and after the watched point is to be painted-over or not is determined. If it is to be painted over, the crossing point data corresponding to the corresponding crossing points is added to the side data so as to create data of divided line segments by the crossing point data for the side, and data of sides connecting between the watched points and the crossing points are newly added. The crossing data, the line segment data and the new side data for all apices, which have been created thereby, are shown in FIG. 6. The crossing point data is shown for crossing points 13 14, 15, 16 and sides 13, 14, 15, 16 which are newly created thereby. Trapezoids having no line segments therein are extracted from the created side data, the line segment data and the new side data, which are thus created. FIG. 7 is a situation such that the polygon shown in FIG. 5 is divided into trapezoids by extraction of the trapezoids.

An intermediate list creating means 11 creates and delivers data of intermediate lists containing data of trapezoids obtained through the division by the trapezoid dividing means 10.

The intermediate list storage means 7 stores therein the intermediate lists created by the intermediate list creating means 11 and the intermediate list creating means 6, and after it stores the intermediate lists for a single page, it delivers them to a printing means 12.

The printing means 12 carries out creation of scan lines, color conversion and tone modulation if the intermediate lists are for trapezoids, and then carries out drawing on a page image in accordance with a super position attribute. Further, drawing is made on the page image for intermediate list which have already been subjected to the tone modulation, in accordance with a superposition attribute. The intermediate lists for the single page are drawn on the page image, and thereafter, the printing output is made.

### Embodiment 3

Explanation will be made of a third embodiment of the present invention with reference to FIG. 5 to 8.

FIG. 8 is a block diagram which shows an image processing apparatus 13 in the third embodiment of the present invention.

Drawing commands delivered from a host computer and the like are at first inputted to an intermediate list format selecting means 14 which determines all apices are convex or not from apex data in the drawing commands. If there are drawing commands having convex apices, a trapezoid dividing means 10 is selected for creation of intermediate lists, and if it is false, an intermediate list creating means 6 is selected.

The intermediate list creating means 6 creates scan lines in the form of an intermediate list in the case of vector drawing, carries out color space conversion of color data in bit map commands into a CMYK color space, and then further carried out tone modulation so as to create binary CMYK data. The binary CMYK data and the drawing position data in the bit map drawing commands, and superposition data are combined so as to form an intermediate list which is then stored in an intermediate list storage means 7.

A trapezoid dividing means 10 divides a polygon into trapezoids. FIGS. 5, 6, 7 show an example of the division into trapezoids. The trapezoid dividing means 10 creates at first data of sides connecting between apices. Then, with the use of Y-ordinate values of the apices, crossing points between the sides and a line in parallel with the X-axis are obtained. In the polygon shown in FIG. 5, crossing points 10, 11, 12 are created for watched points. Then, the watched points and the crossing points are rearranged in the order of ascending X-ordinate values, whether a line segment between crossing points before and after each of the watched points is to be painted over or not is determined. If it is to be painted over, crossing point data corresponding to the corresponding crossing points are added to the side data so as to create data of line segments obtained through division of the sides by the crossing point data, and data of sides connecting between the watched apices and the crossing points are newly add. Thus, FIG. 6 shows the crossing points, the line segment data and the new side data, which have been created for all apices. The crossing point data are shown in the figure, as to crossing points 13, 14, 15, 16 and sides 13, 14, 15, 16 which have been created thereby. With the use of the side data, the line segment data and the new side data, which have been thus created, trapezoids each of which has no line segment there are extracted. FIG. 7 shows a situation in which the polygon shown in FIG. 5 is divided into the trapezoids through extraction of trapezoids.

An intermediate list creating means 11 creates and delivers date of intermediate lists containing data of trapezoids obtained through the division into trapezoids by the trapezoid dividing means 11.

An intermediate list storage means 7 stores intermediate lists created by the intermediate list creating means 11 and the intermediate list creating means 6, and after it stores intermediate lists for a single page, it delivers them to a printing means 16.

The printing means 16 carries out creation of scan lines, color conversion and tone modulation, and makes drawings on an page image in accordance with a superposition attribute if an intermediate list concerns a trapezoid, but carries out color conversion and tone modulation, makes drawing on the page image in accordance with a superposition attribute if an intermediate list concerns scan lines, and makes drawing on the page image, for intermediate lists which have always been subjected to the tone modulation, in accordance with a superposition attribute. After the intermediate lists for a single page is drawn on the page image, the printing output is carried out.

As mentioned above, according to the present invention, by holding the intermediate lists with polygons, the size of the intermediate lists can be reduced, and by holding the intermediate lists in which the polygon is divided into trapezoids, the side of the intermediate lists can be reduced, and the development of a printing image after the storage of the intermediate lists can be made at an increased speed.

What is claimed is:

1. An image processing apparatus for converting received drawing commands into an intermediate list which is exhibited by simple commands, which is then stored, and from which a page image is formed, comprising an intermediate list format selecting means for selecting a format of an intermediate list in accordance with the drawing commands, a polygon dividing means for dividing a pattern into polygons, a paint-over determining means for determining whether the interior of a polygon is a part to be painted-over or not, a first intermediate list creating means for creating an intermediate list containing polygon data, a second intermediate list creating means for creating an intermediate list containing line data as to a width l or bit map data, an intermediate list storing means for storing the intermediate lists, and a printing means for creating a raster image from the intermediate lists stored in the intermediate storing means in response to printing instructions, and printing the image.

2. An image processing apparatus for converting received drawing commands into an intermediate list which is exhibited by simple commands, which is then stored, and from which a page image is formed, comprising an intermediate list format selecting means for selecting a format of an intermediate list in accordance with the drawing commands, a polygon dividing means for dividing a pattern into polygons, a paint-over determining means for determining whether the interior of a polygon is a part to be painted-over or not, a trapezoid dividing means for dividing a polygon into a group of trapezoids, a first intermediate list creating means for creating an intermediate list containing trapezoid data, a second intermediate list creating means for creating an intermediate list containing line date as to a width l or bit map data, an intermediate list storing means for storing the intermediate lists, and a printing means for creating an raster image from the intermediate lists stored in the intermediate list storing means in response to printing instructions and printing the image.

3. An image processing apparatus for converting received drawing commands into an intermediate list which is exhibited by simple commands, which is then stored, and from which a page image is formed, comprising an intermediate list format selecting means for selecting a format of an intermediate list in accordance with the drawing commands, a trapezoid dividing means for dividing a polygon into a group of trapezoids, a first intermediate list creating means for creating an intermediate list containing trapezoid data, a second intermediate list creating means for creating an intermediate list containing line data as to a width l or bit map data, an intermediate list storing means for storing the intermediate lists, and a printing means for creating an raster image from the intermediate lists stored in the intermediate list storing means in accordance with printing instructions and printing the image.
